(19) United States
(12) Patent Application Publication
(10) Pub. No.: US 2026/0202716 A1
(43) Pub. Date: Jul. 16, 2026

(54) LENS UNIT AND IMAGING APPARATUS

(71) Applicant: Tamron Co., Ltd., Saitama (JP)

(72) Inventor: Kaori SATO, Saitama (JP)

(73) Assignee: Tamron Co., Ltd., Saitama (JP)

(21) Appl. No.: 19/381,700

(22) Filed: Nov. 6, 2025

(30) Foreign Application Priority Data
Jan. 15, 2025 (JP) 2025-005749

(51) Int. Cl. G03B 13/34; G02B 7/04

(52) U.S. Cl. CPC G03B 13/34; G02B 7/04

(57) ABSTRACT

A lens unit includes an MF ring that operates a focus lens group (F group) of a lens optical system, and a CPU that controls the operation of the MF ring and the working of the F group. The CPU sets two or more sections in a working range of the F group and an operation sensitivity of the MF ring for each section, and works the F group according to the setting.

### CROSS-REFERENCE TO RELATED APPLICATIONS

This application is based on and claims the benefit of priority from Japanese Patent Application No. 2025-005749, filed on January 15, 2025, the entire contents of which are incorporated herein by reference.

### BACKGROUND OF THE INVENTION

### Technical Field

The present invention relates to a lens unit and an imaging apparatus.

### Related Art

With the spread of various moving image hosting sites, a technique suitable for moving image photographing is also required for cameras capable of photographing moving images, such as mirrorless cameras. For example, there is known a camera or a lens unit in which a focus operation is important in moving image photographing, and a rotation angle of a manual focus (MF) ring (also referred to as “operation sensitivity” of the MF ring) when the focus lens group reaches from an infinite end to a close end can be selected as an arbitrary rotation angle for the manual focus (MF) ring operation in moving image photographing (e.g., see JP 2021-184008 A and WO 2020/100243 A2).

In the moving image photographing, MF is one of expression means, and it is important to “move to desired focus position at desired speed and desired timing”. Since the process of movement is also included in the expression, a highly reproducible linear operation ring is usually used in the moving image photographing. In order to realize the intended expression, either moving the MF ring little by little or moving the MF ring all at once may be required depending on the situation. As described above, the optimum operation sensitivity in the operation of the MF ring in the moving image photographing depends on the positional relationship of the subject or the optical performance of the lens unit, and thus cannot be unconditionally determined.

However, in the conventional technique as described above, there is a problem that only one operation sensitivity of the MF ring can be determined in the entire range of the working range of the focus lens group. Therefore, in the photographing of a moving image, for example, in a case where it is desired to use some operation sensitivities according to a scene, it is necessary to select a desired operation sensitivity from a menu for each scene. In such a selecting operation, it is necessary to interrupt the photographing of a moving image for each desired operation sensitivity, which makes it difficult to continuously photograph a moving image for a long time. As described above, in the related art, there is still room for examination from the viewpoint of changing, at the time of photographing the moving image, the operation sensitivity of an optical element to an appropriate operation sensitivity without interrupting the photographing.

An object of one aspect of the present invention is to provide a lens unit and an imaging apparatus capable of changing operation sensitivity of an optical element during photographing without interrupting photographing.

### SUMMARY OF THE INVENTION

In order to solve the above problem, a lens unit according to one aspect of the present invention includes: a lens optical system including an optical element to be operated, an operation unit that is an operable operation unit and configured to work the optical element according to an operation amount to change an operation of the optical element in the lens optical system, and a control unit configured to execute a setting process of setting two or more sections in a working range of the optical element on which the optical element operates in the lens optical system and two or more different operation sensitivities of the operation unit corresponding to each of the two or more sections, and a working process of working the optical element with the operation sensitivities set in the setting process in the sections set in the setting process to change the operation of the optical element according to the operation of the operation unit.

Furthermore, in order to solve the above problem, an imaging apparatus according to one aspect of the present invention includes the lens unit described above, and an image sensor configured to convert an optical image formed by the lens unit into an electrical signal on an image plane side of the lens unit.

According to one aspect of the present invention, a lens unit and an imaging apparatus capable of changing operation sensitivity of an optical element during photographing without interrupting photographing can be provided.

### BRIEF DESCRIPTION OF THE DRAWINGS

FIG. 1 is a diagram for describing, based on a first display example, an operation sensitivity of an MF ring according to an embodiment of the present invention;

FIG. 2 is a diagram for describing, based on the first display example, the operation sensitivity of the MF ring according to an embodiment of the present invention;

FIG. 3 is a diagram illustrating a set operation sensitivity in a lens unit according to a first embodiment of the present invention;

FIG. 4 is a flowchart illustrating an example of a setting process in the lens unit according to the first embodiment of the present invention;

FIG. 5 is a diagram illustrating a set operation sensitivity in a lens unit according to a second embodiment of the present invention;

FIG. 6 is a diagram illustrating a first example of an operation sensitivity of a buffer section in the second embodiment of the present invention;

FIG. 7 is a diagram illustrating a second example of the operation sensitivity of the buffer section in the second embodiment of the present invention;

FIG. 8 is a diagram illustrating a third example of the operation sensitivity of the buffer section in the second embodiment of the present invention;

FIG. 9 is a diagram illustrating a fourth example of the operation sensitivity of the buffer section in the second embodiment of the present invention;

FIG. 10 is a diagram illustrating a set operation sensitivity in a lens unit according to a third embodiment of the present invention;

FIG. 11 is a flowchart illustrating an example of a setting process in the lens unit according to the third embodiment of the present invention;

FIG. 12 is a flowchart illustrating an example of a working process in the lens unit according to the third embodiment of the present invention;

FIG. 13 is a diagram illustrating a set operation sensitivity in a lens unit according to a fourth embodiment of the present invention; and

FIG. 14 is a flowchart illustrating an example of a setting process in the lens unit according to the fourth embodiment of the present invention.

### DESCRIPTION OF THE EMBODIMENTS

Embodiments of the present invention enables operation sensitivity of an operation unit of an optical element to be set independently for each of a plurality of different sections within a controllable range of the optical element that produces an optical effect, and enables the optical element to be worked by operation of the operation unit with the set operation sensitivity. Hereinafter, embodiments of the present invention will be described. In the following description, an embodiment of the present invention will be described mainly based on an aspect including an “operation ring” as an “operation unit” in the present invention.

### Lens unit

A lens unit according to an embodiment of the present invention includes a lens optical system, an operation ring, and a control unit.

### Lens optical system

The lens optical system is an optical system including at least one lens. In the present embodiment, the lens optical system includes an optical element to be operated in the present embodiment. The optical element is an optical configuration having a specific working range in the lens optical system, being operable by the operation ring, and exhibiting a specific optical effect in the lens optical system. Examples of the optical element include a focus lens group, a zoom lens group, and an aperture diaphragm. Furthermore, examples of the lens optical system according to the present embodiment include a zoom lens, a varifocal lens, and a single focus lens.

### Operation ring

In the present embodiment, the operation ring is rotatable, and is configured to work the optical element according to the rotation amount to change the operation of the optical element in the lens optical system. The operation ring may be, for example, a ring-shaped member exposed to the outer peripheral side of the lens barrel including the lens optical system and arranged to be movable in the peripheral direction of the lens barrel. The operation ring may be provided according to the optical element, and examples thereof include an MF ring, a diaphragm ring, a control ring, and a zoom ring.

### Control unit

The control unit may be configured to realize a setting process and a working process described later with respect to the operation of the optical element by the rotary motion of the operation ring. For example, the control unit is configured to execute the setting process according to an input signal from a user, and control the working of the optical element by the operation ring based on the set content. Examples of the control unit include a central processing unit (CPU) and a graphics processing unit (GPU).

### Setting process

The setting process is a process of setting two or more sections and two or more different operation sensitivities of the operation ring corresponding to each of the two or more sections in a working range of the optical element in which the optical element operates in the lens optical system.

The set “section” can be determined based on the position of the optical element in the working range of the optical element. For example, in the section, the boundary between two or more sections can be set by the position of the optical element in the working range of the optical element. According to the setting of such a scene, it is possible to continuously photograph two or more scenes in which different operations of the optical element are required, with suitable operation sensitivity corresponding to each scene, without changing the operation sensitivity (interrupting photographing).

The working range of the optical element is a range in which the optical element is worked to operate, and is, for example, a movable range of the focus lens group. The movable range includes a position where a photographing distance in the imaging apparatus becomes an infinite end and a position where the photographing distance becomes a close end. In the case of the diaphragm ring, the range of aperture is from fully open to fully closed.

The working range may be replaced to an extent of an optical effect by the optical element. For example, in the case of the focus lens group, the working range can be a range of a photographing distance from the infinite end to the close end. Note that the “photographing distance” means a distance from an image plane of the image sensor to the in-focus position in the imaging apparatus, and is, for example, a distance from the image plane of the image sensor to the subject in a state where the subject is focused.

The set “operation sensitivity” is sensitivity (or insensitive) of the operation of the optical element with respect to the operation of the operation ring, and may be a proportion of the working amount of the optical element with respect to the rotation amount of the operation ring. The operation sensitivity can also be expressed by the rotation angle of the operation ring required to work from one end to the other end of the working range of the optical element, and is displayed by such a rotation angle in the present embodiment.

Regarding the operation sensitivity, the operation sensitivity may be unchanged with respect to a change in operation of the optical element in at least one of the two or more sections. In this case, since one operation sensitivity is set for one set section, it is preferable from the viewpoint of realizing photographing with suitable operation sensitivity according to the subject. For example, it is possible to perform photographing according to the subject, such as setting a high (sensitive) operation sensitivity suitable for following the motion of the subject for the first subject accompanied by the motion and setting a low (insensitive) operation sensitivity with respect to the stationary subject.

Regarding the operation sensitivity, the operation sensitivity may be unchanged with respect to a change in operation of the optical element in at least one of the two or more sections. In this case, since one operation sensitivity changes in one set section, it is preferable from the viewpoint of realizing photographing that exhibits a video effect due to a change in the operation of the optical element in the set section. For example, a lens work (operation of a lens unit) that realizes photographing in which a scene change is expressed by a change in operation of an optical element is possible.

The mode of change in the operation sensitivity in this case is not limited, and may be, for example, a linear change, that is, a linear function change, or a non-linear change, that is, a change including a change represented by a high-order function. The linear change can be expressed by a linear function, and is suitable from the viewpoint of simplification of the setting process. The non-linear change can be expressed by a high-order function, a combination thereof, or a combination of a linear function and a high-order function, and is suitable from the viewpoint of enhancing the video effect due to the change in the operation of the optical element.

Furthermore, the operation sensitivity may be set in accordance with the direction of change in operation of the optical element in at least one of the two or more sections. In this case, in one set section, for example, when the operation of the optical element changes in one direction, the optical element is operated with the first operation sensitivity, and when the operation changes in the other direction, the optical element is operated with the second operation sensitivity. Therefore, it is preferable from the viewpoint of photographing the subject with suitable operation sensitivity when the photographing of the specific subject continues after the photographing of the video effect due to the change in the operation of the optical element. For example, the first scene is first photographed by the lens work, and then the video is changed from the first scene by the lens work, and this is suitable when a specific subject is photographed in the second scene in the middle of the change.

Furthermore, in the setting process, the two or more sections to be set may further include a buffer section adjacent to at least one of the sections. The operation sensitivity of the buffer section can be set so as to gradually change to the reference operation sensitivity or the reference operation sensitivity when the operation sensitivity set in the section adjacent to the buffer section is defined as the reference operation sensitivity.

The buffer section is a section set adjacent to one specific section. In photographing in a specific section, in a case where there is movement in the subject, the position of the optical element may temporarily or slightly exceed the one section by the operation of the operation ring. In this way, in a case where there is a possibility that the optical element runs out from the section, the setting of the buffer section and the operation sensitivity thereof is preferable from the viewpoint of being able to prevent a sudden change in the operation sensitivity in the same scene and maintaining or enhancing the comfort of the moving image photographing by the user.

Since the buffer section can be a preliminary section for one specific section, the buffer section can be appropriately set from such a viewpoint. For example, the buffer section can be appropriately set according to various conditions such as the position of the optical element, the operation sensitivity of the operation ring, the operation accuracy of the user, the photographing distance, and the depth of field.

For example, in the case of the operation sensitivity, since the movement amount of the optical element with respect to the operation amount (rotation angle) of the operation ring is large in the buffer section adjacent to the specific section set to high operation sensitivity, it is preferable from the above viewpoint to set the buffer section large with respect to the adjacent specific section such as, for example, size of 10 to 30% of the specific section. Furthermore, since the movement amount of the optical element with respect to the operation amount (rotation angle) of the operation ring is small in the buffer section adjacent to the specific section set to low operation sensitivity, it is preferable from the above viewpoint to set the buffer section small with respect to the adjacent specific section such as, for example, size of 1 to 10% of the specific section.

The setting operation in the setting process described above can be performed using a lens unit or using a device capable of performing transmission/reception therewith. For example, the setting operation can be performed using various types of rings and switches or buttons in the lens unit, can be performed using an external device connectable to the lens unit via a connection terminal, or can be performed using a camera main body to which the lens unit is mounted. In addition, the operation of setting the operation sensitivity so as to change in a specific section can be performed by inputting or selecting a function representing a mode (linear, nonlinear, etc.) of change.

### working process

The working process is a process of working the optical element with the operation sensitivity set by the setting process in the section set in the setting processing according to the rotation of the operation ring to change the operation of the optical element. The working process can be realized, for example, by further performing, in a known working process in a lens optical system that works the optical element with the operation sensitivity set according to the rotation of the operation ring, a process of detecting a position in a working range of the optical element and a process of working the optical element with the operation sensitivity set at the detected position.

### Other Configurations

The lens unit of the present embodiment may further have a configuration other than the above-described configuration in a scope in which the effect of the present invention can be obtained. For example, the lens unit may further include a switch or a button for the user to input a set value in the setting process described above, or a connection terminal for connecting an external device.

### Application target

The lens unit of the present embodiment may include an operation ring for operating the optical element according to the mode of the optical element. For example, the optical element may be a focus lens group, and the operation ring may be an MF ring. In this case, the operation sensitivity of the MF ring can be arbitrarily set in each of the plurality of sections in the working range from the infinite end to the close end of the focus lens group, and a moving image excelling in the video effect of focusing can be created.

Alternatively, the optical element may be an aperture diaphragm and the operation ring may also be a diaphragm ring. In this case, the operation sensitivity of the diaphragm ring can be arbitrarily set in each of the plurality of sections in the working range from the fully open state to the fully closed state of the aperture diaphragm, and a moving image excelling in the video effect of the brightness of the image and the video effect of the depth of field can be created.

Alternatively, the optical element may be an aperture diaphragm and the operation ring may be a control ring. In this case, the operation sensitivity of the control ring can be arbitrarily set in each of the plurality of sections in the working range from the fully open state to the fully closed state of the aperture diaphragm. It is possible to create a moving image excelling in a video effect of the brightness of the image and a video effect of the depth of field.

Alternatively, the operation target may be the ISO sensitivity of the camera, and the operation ring may be the control ring. In this case, the operation sensitivity of the control ring can be arbitrarily set in each of the plurality of sections in the working range from the minimum to the maximum of the ISO sensitivity, and a moving image excelling in the video effect of the brightness of the image can be created.

Alternatively, the optical element may be a lens group of an electric zoom lens, and the operation ring may be a zoom ring. In this case, the operation sensitivity of the zoom ring can be arbitrarily set in each of the plurality of sections in the working range of each lens group from the telephoto end to the wide angle end, and a moving image excelling in a video effect of variable power can be created.

### Imaging apparatus

An imaging apparatus according to an embodiment of the present invention includes the lens unit of the embodiment described above, and an image sensor configured to convert an optical image formed by the lens unit on an image plane side of the lens unit into an electrical signal. The imaging apparatus can include, for example, a camera main body and a lens barrel attached to the camera main body by way of a mount. The lens barrel is an aspect of the lens unit of the embodiment described above. Examples of the imaging apparatus of the present embodiment preferably include a mirrorless camera, but the imaging apparatus of the present embodiment can be various imaging apparatuses such as a security camera, a digital still camera, or a medical camera.

The camera main body includes, for example, an image sensor and a cover glass. The image sensor is an element configured to convert an optical image into an electrical signal, and is, for example, a solid-state image sensor. Examples of the solid-state image sensor include a charge coupled device (CCD) sensor and a complementary metal-oxide semiconductor (CMOS) sensor.

The imaging apparatus of the present embodiment may include an additional optical element other than the optical configuration described above in the lens unit within a range in which the effect of the present invention can be obtained and according to the application of the imaging apparatus. For example, in the imaging apparatus, examples of the additional optical element include a parallel flat plate having substantially no refractive power and an infrared cut filter (IRCF).

### Description of specific aspect

Hereinafter, an embodiment of the present invention will be described more specifically by taking a focus function in a lens unit as an example.

In the following description, the lens unit includes a plurality of lens groups. The lens group includes a focus lens group that moves along the optical axis at the time of focusing. In the lens barrel of the lens unit, an MF ring that can be rotation operated by a user is disposed. In the lens unit, the focus lens group is configured to be movable by rotation of the MF ring from a position where the focus position is an infinite end (hereinafter, also simply referred to as “infinite end position”) to a position where the focus position is a close end (hereinafter, also simply referred to as a “close end position”). The lens unit is configured such that the focus lens group moves along the optical axis with predetermined operation sensitivity according to the rotating direction of the MF ring by electronic control.

In the following description, the lens unit includes a CPU serving as the control unit described above. In addition, the lens unit further includes, as appropriate, a configuration for performing the setting process described above or inputting a set value, such as a switch or a connector, according to an aspect of the process or the input.

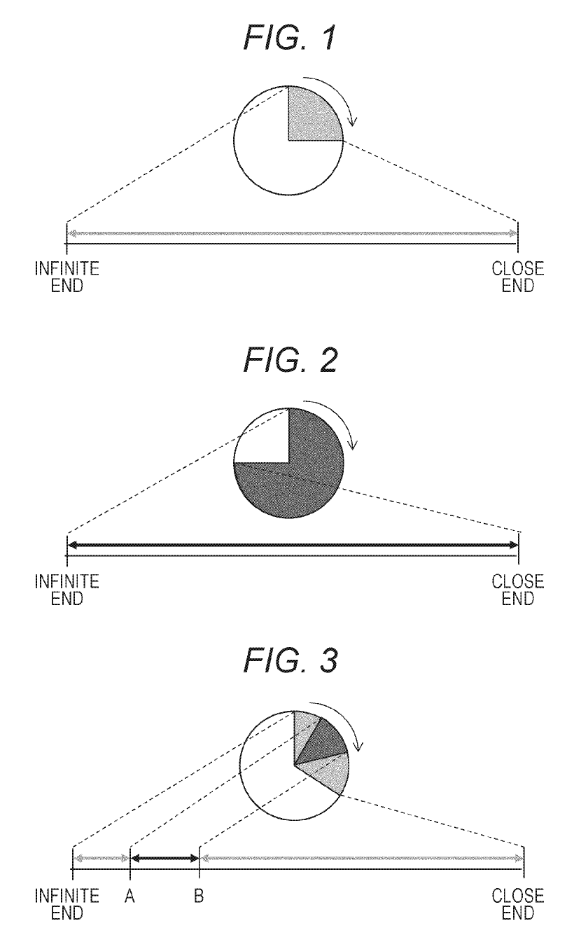

Here, the operation sensitivity of the MF ring will be described with reference to FIGS. 1 and 2. FIG. 1 is a diagram for describing an MF ring having an operation sensitivity of 90°, and FIG. 2 is a diagram for describing an MF ring having an operation sensitivity of 270°. It is assumed that the 12:00 position in the MF ring corresponds to the position on the optical axis in the lens unit of the focus lens group where the focus position is at the infinite end. When rotated in the clockwise direction, the MF ring moves the focus lens group from the position of the infinite end to the close end side.

As illustrated in FIG. 1, in a case where the operation sensitivity is 90°, when the MF ring is rotated in the clockwise direction by 90°, the focus lens group reaches from the position where the focus position is at the infinite end to the position where it is at the close end. Furthermore, as illustrated in FIG. 2, in a case where the operation sensitivity is 270°, when the MF ring is rotated in the clockwise direction by 270°, the focus lens group reaches from the position where the focus position is at the infinite end to the position where it is at the close end.

An embodiment of the present invention will be further described below. In the following description of the embodiment, the lens unit is a zoom lens with a plurality of lens groups including a focus lens group. The zoom lens is an electric zoom lens implemented by electronically controlling a variable power operation, includes various types of rings (focus ring (MF ring), zoom ring, and control ring) for manual operation, further includes a built-in CPU corresponding to the control unit described above, and includes the connection terminal described above such as a USB terminal. Furthermore, the zoom lens is configured to be detachable from the camera main body described above via a mount, and is attached to the camera main body to constitute the imaging apparatus described above. Note that in the following description, for the sake of convenience of description, the description of a member having the same function as the member described above will not be repeated.

### First embodiment

In the present embodiment, in the lens unit, point A and point B are set between the position of infinite end and the close end in the working range of the focus lens group, and in the working range, three sections of between the position of infinite end and point A, between point A and point B, and between point B and the position of close end are set. On the other hand, the operation sensitivity of the MF ring in the lens unit of the present embodiment is set to 90° as a default value, and the operation sensitivity of the MF ring is set to 270° only in the section (A - B section) between point A and point B. As a result, as illustrated in FIG. 3, the operation sensitivity of the MF ring in the infinite end - A section is set to 90°, the operation sensitivity of the MF ring in the A - B section is set to 270°, and the operation sensitivity of the MF ring in the B - close end section is set to 90°.

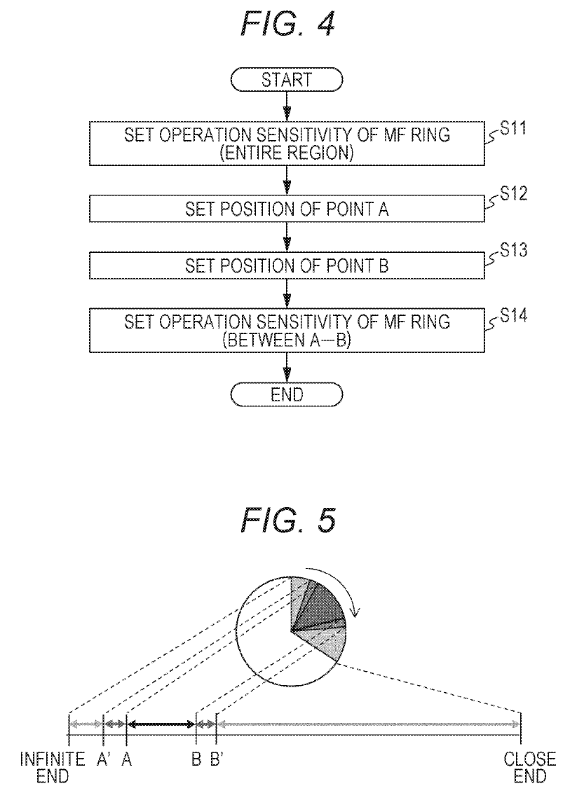

An example of a setting process for setting such sections and operation sensitivities is illustrated in FIG. 4. In step S11, the operation sensitivity of the MF ring is set to 90° for the entire region in the working range of the focus lens group. Next, in step S12, the position of point A in the working range is set, and then in step S13, the position of point B in the working range is set.

The setting of point A and point B can be executed by inputting point A and then point B from the infinite end side by using, for example, a button for input provided in the lens unit. The positions of points A and B at this time may be determined, for example, according to the rotation amount of the MF ring at the time of input of each point (e.g., by a specific rotation angle when one rotation is defined as the entire working range). Alternatively, it can be executed by inputting two desired focus positions by an external device such as a smartphone or a personal computer, and among the positions of the focus lens group corresponding to each focus position, setting the position on the most infinite end side as point A, and then the position on the close end side as point B. Alternatively, in a state where the lens unit is attached to the camera main body, the setting may be performed by operating the above-described input button while viewing the display screen of the camera main body.

Next, in step S14, the operation sensitivity of the MF ring in the A - B section is set to 270°. The position (each section) and the operation sensitivity of each point set in the setting process are recorded in, for example, the CPU. The setting of the operation sensitivity can also be performed using the above-described MF ring, an input button, an external device or an input device of a camera main body. For example, the user registers point A and point B by pressing a button of the lens unit (the previous button operation is point A, the subsequent button operation is point B, etc.). On the other hand, in a state of being connected to an external device such as a personal computer, the user sets the operation sensitivity (or the photographing distance) between point A and point B in the external device.

Then, the CPU of the lens unit controls the movement of the focus lens group by the rotation of the MF ring according to the setting of the operation sensitivity. Such a working process can be performed, for example, by the CPU referring to the detection of the working position of the focus lens group and the set value of the operation sensitivity by the setting process and controlling the operation of the drive device of the focus lens group so that the movement amount of the focus lens group with respect to the rotation amount of the MF ring becomes the set operation sensitivity.

Here, setting of focusing will be described with a more specific scene as an example. For example, when focusing is performed in the order of subject A - subject B - focusing out, depending on the position relationship, the optimum rotation angle of the MF ring between subject A and subject B may be different from the optimum rotation angle of the MF ring between subject B and focus out. In this case, for example, when the rotation angle of the MF ring is set to be large (operation sensitivity is blunted) in accordance with between the subject A and the subject B, the rotation amount of the MF ring required between the subject B and the focusing out increases, and the focusing out tends to be difficult at an intended speed. On the other hand, when the rotation angle of the MF ring is decreased in accordance with between the subject B and the focusing out, a delicate MF operation between the subjects A and B tends to be difficult.

Furthermore, for example, in a scene of a position relationship between the persons A and B who are facing each other and a distant mountain, it is necessary to perform an operation so as not to be out of focus from the speaker in a scene of a conversation between the persons A and B, and the operation sensitivity at this time is preferably insensitive. On the other hand, in a case where the focus is shifted from the conversation between the two persons to the mountain, it is necessary to perform the operation so that the focus shift is not delayed, and the operation sensitivity at this time is preferably sensitive.

According to the present embodiment, in the lens unit, due to the rotation of the MF ring by the user, the focus position changes relatively sensitively between the position of the infinite end and point A, the focus position changes relatively bluntly between point A and point B, and the focus position changes relatively sensitively between point B and the position of the close end. According to the setting of such a focus function, for example, it is possible to continuously photograph a series of scenes in which appropriate different operation sensitivities exist between scenes, such as photographing a distant scene, then quickly focusing on a specific subject at a position closer than the distant scene and photographing the specific subject, and then shifting the focus from the specific subject to a stationary object at a near place and photographing the stationary object, so that photographing can be continuously performed with an appropriate operation sensitivity without changing the operation sensitivity in the middle.

Note that in the present embodiment, a further point may be set other than point A and point B, and a section divided by the further point and the operation sensitivity corresponding thereto may be further set.

### Second embodiment

In the first embodiment described above, the operation sensitivity changes with point A or point B as a boundary, but from the viewpoint of alleviating such a change in the operation sensitivity, a buffer section adjacent to the A - B section may be further set as illustrated in FIG. 5. The present embodiment is similar to the first embodiment described above except that point A’ is set on the infinite end side of point A, point B’ is set on the close end side of point B, and specific operation sensitivity is set in each of the A’ - A section and the B - B’ section.

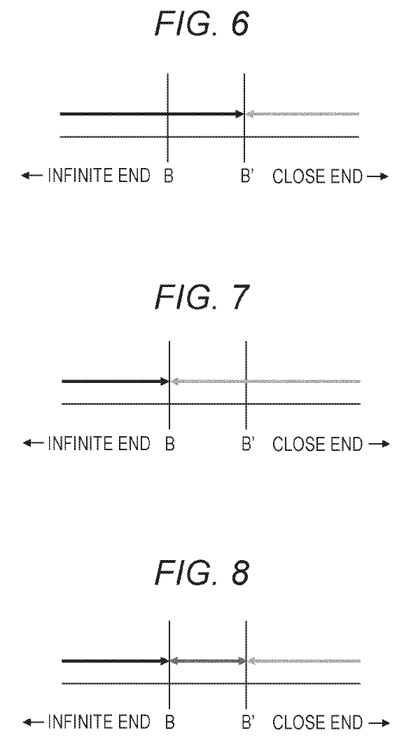

The A’ - A section and the B - B’ section are both buffer sections. The setting of the operation sensitivity of the buffer section will be described using the B - B’ section as an example. The same operation sensitivity as the operation sensitivity of the adjacent section may be set in the buffer section. For example, as illustrated in FIG. 6, the operation sensitivity (270°) of the A - B section adjacent to the infinite end side may be set to the B - B’ section which is the buffer section, or as illustrated in FIG. 7, the operation sensitivity (90°) of the B - close end section adjacent to the close end side of the B - B’ section may be set.

Similarly to point A and point B in the first embodiment described above, the buffer section and the operation sensitivity thereof can be sequentially set, for example, from the infinite end side as each of a plurality of set points and sections by the points. Alternatively, after point A and point B are set, a buffer section for point A and point B may be further set. In this case, the size (position of point A’ with respect to point A or position of point B’ with respect to point B) and the operation sensitivity of the buffer section may be set according to further setting of the buffer section. The working process of the focus lens group in each buffer section can be performed in the same manner as that in the A - B section in the first embodiment described above.

In a case where the operation sensitivity (270°) of the operation sensitivity of the A - B section is set as the operation sensitivity of the B - B’ section, the operation sensitivity in the photographing of the specific subject in the A - B section is continuously applied even in a case where the focus position slightly goes toward the close end side from point B in the photographing of the specific subject in the A - B section. Therefore, for example, even if the focus position of the photographing of the specific subject in the A - B section slightly runs out from the A - B section, the operation sensitivity appropriate for the photographing of the specific subject is applied, and the user who performs the photographing can perform comfortable photographing regardless of the slight deviation. Such setting of the buffer section is suitable in a case where the scene temporarily ends in the A - B section, or is suitable in a case where a specific subject in the A - B section involves slightly moving.

In a case where the operation sensitivity (90°) of the operation sensitivity in the B - close end section is set as the operation sensitivity in the B - B’ section, the change in the operation sensitivity on the point B side in the A - B section is the same as that in the first embodiment described above. Such setting of the buffer section is suitable in a case where the scene continues to further shift to the close end side from the A - B section, or is suitable in a case where a specific subject in the A - B section is fixed or moves only slightly, and it is desired to further emphasize a change in the video focused on the close end side.

Alternatively, in the buffer section, as illustrated in FIG. 8, an operation sensitivity different from any of the operation sensitivities in the adjacent sections on both sides, for example, an intermediate operation sensitivity between the operation sensitivities on both sides may be set. The setting of such a buffer section is effective from the viewpoint of alleviating a change in the operation sensitivity from the operation sensitivity (270°) in the A - B section to the operation sensitivity (90°) in the B' - close end section by setting the operation sensitivity in the buffer section to the intermediate value (180°), for example, and preventing an unintended video from being photographed due to a sudden change in the operation sensitivity.

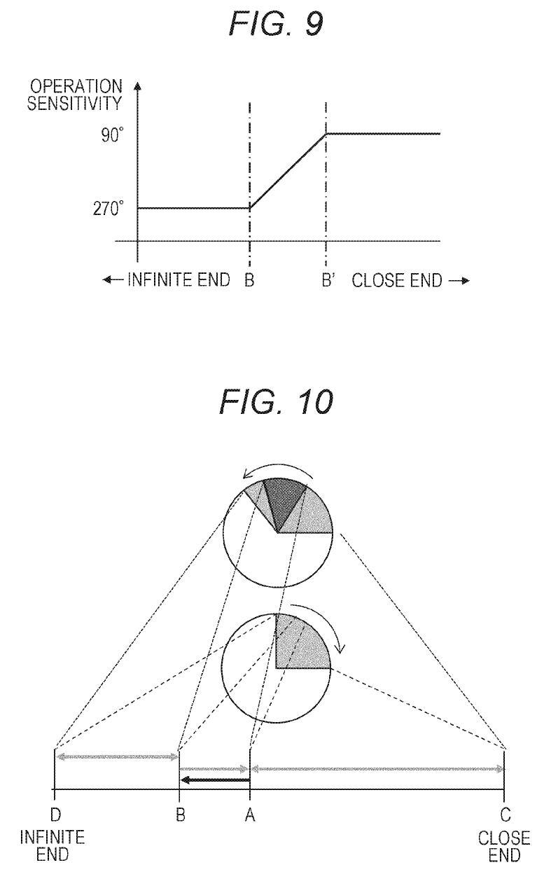

Alternatively, in the buffer section, as illustrated in FIG. 9, the operation sensitivity that continuously changes toward the operation sensitivities of each of the adjacent sections on both sides may be set. Such setting of the buffer section is also effective from the viewpoint of alleviating the change in the operation sensitivity as described above. In addition, for example, in a case where the focus is shifted from the AB section to the close end side, it is effective from the viewpoint of enhancing the accent of defocusing from a specific subject in the A - B section since the focusing speed increases as the distance from the A - B section increases. Note that such continuously changing operation sensitivity and its setting will be described later in a fourth embodiment.

Note that, in the present embodiment, the positions of point A’ and point B’ may be determined by default values for point A or point B, may be determined according to the depth of field at point A or point B, or may be arbitrarily determined by the user.

Furthermore, in the present embodiment, the operation sensitivity of the buffer section may be set in accordance with the rotating direction of the MF ring. For example, in a scene of conversation, there may be a case where the focus goes back and forth many times between point A and point B. In this case, for example, in a case where the operation sensitivity changes from point B to point B’, it is effective to apply the same operation sensitivity as the operation sensitivity of the A - B section to the operation sensitivity of the B - B’ buffer section from the viewpoint of preventing an unintended change in the operation sensitivity due to deviation from the A - B section, and it is suitable from the viewpoint of the user comfortably photographing such a scene. Setting of the operation sensitivity in accordance with the rotating direction of the MF ring will be described later in a third embodiment.

### Third embodiment

The present embodiment is the same as the first embodiment described above except that the operation sensitivity is set only in a certain direction in the A - B section and the positions of point A and point B are switched. In the present embodiment, description will be made with the close end as point C, and the infinite end as point D.

In the present embodiment, as illustrated in FIG. 10, the operation sensitivity is set to a default value of 90° in the entire working range. However, in the A - B section, the operation sensitivity is set to 270° only in the direction from the close end side to the infinite end.

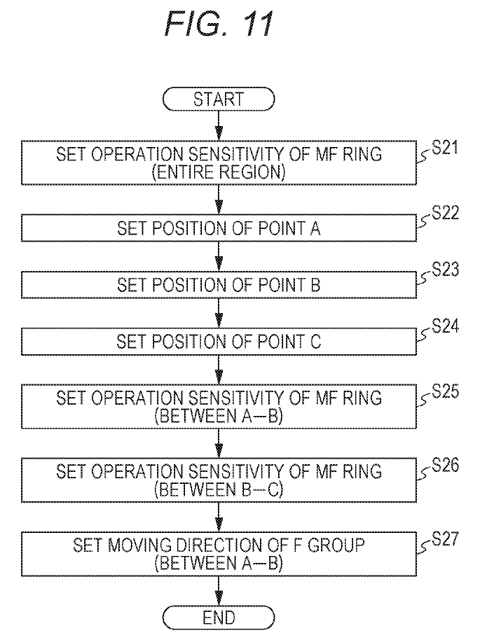

FIG. 11 illustrates an example of a setting process for setting the section and the operation sensitivity in the present embodiment. In step S21, the operation sensitivity of the MF ring is set to 90° for the entire region in the working range of the focus lens group. Next, in step S22, the position of point A in the working range is set, then in step S23, the position of point B in the working range is set, and then in step S24, the position of point C in the working range is set. The setting of each point can be executed similarly to that in the first embodiment described above.

Next, in step S25, the operation sensitivity of the MF ring in the A - B section is set to 270°, and then in step S26, the operation sensitivity of the MF ring in the B - C section is set to 90°. The setting of the operation sensitivity can also be executed similarly to that in the first embodiment described above.

Next, in step S27, the moving direction of the focus lens group (F group) to which the operation sensitivity of the MF ring in the A - B section is applied is set. The setting of the moving direction can also be performed by using the MF ring, the input button, the external device or the input device of the camera main body.

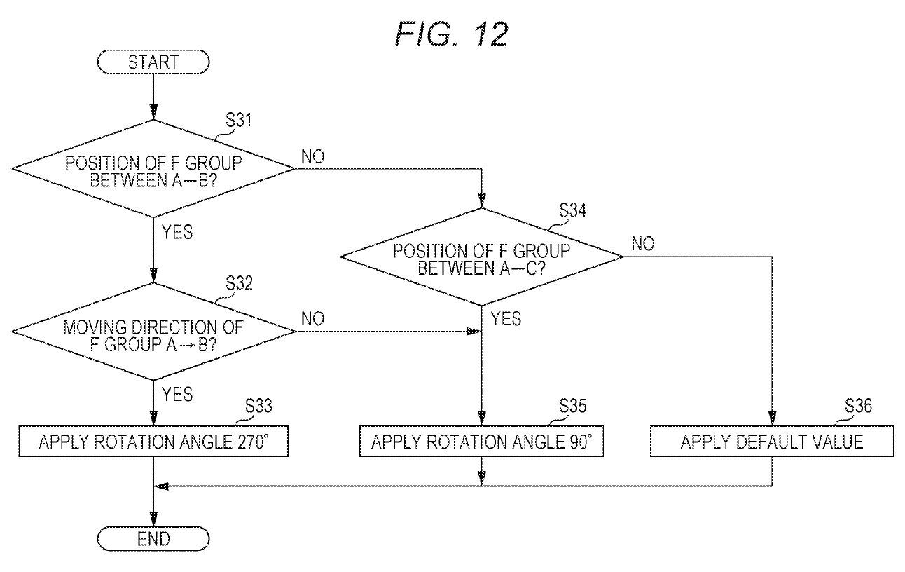

Then, the CPU of the lens unit executes a working process of controlling the movement of the focus lens group by the rotation of the MF ring based on the condition set in the setting process described above. An example of the working process in the present embodiment is illustrated in FIG. 12. In step S31, the CPU determines whether or not the position of the focus lens group is in the A - B section.

In a case where the position of the focus lens group is in the A - B section, in step S32, the CPU determines whether or not the moving direction of the focus lens group is the direction from the point A side toward the point B side.

In a case where the moving direction of the focus lens group is the direction from the point A side to the point B side, in step S33, the CPU controls the operation sensitivity of the MF ring to the operation sensitivity (270°) set in the case of that direction.

In a case where the position of the focus lens group is not in the A - B section in step S31, the CPU determines whether or not the position of the focus lens group is in the A - C section in step S34. In a case where the position of the focus lens group is in the A - C section, or in a case where the moving direction of the focus lens group is not the direction from the point A side toward the point B side in step S32, the CPU controls the operation sensitivity of the MF ring to the operation sensitivity (90°) set in the A - B section and the B - C section in a case other than the above directions in step S35.

In a case where the position of the focus lens group is not in the A - C section in step S34, the CPU controls the operation sensitivity of the MF ring to the operation sensitivity (90°) set to the default value in step S36.

In moving image photographing, a focus position is often shifted in a direction farther away from a position at which a main subject is focused in order to blur more at the time of focusing out. As in the setting in the present embodiment, for example, in a case where focusing out is performed from a subject (e.g., persons) closer to the infinite end, focusing is often performed on the close end. The present embodiment is suitable from the viewpoint of enhancing the effect of focusing out from a specific subject closer to the infinite end.

### Fourth Embodiment

In the present embodiment, point A is set between the infinite end and the close end, and the operation sensitivity is set so as to continuously change in each section between the infinite end and point A and between point A and the close end. In the present embodiment, description will be made with the infinite end as point B, and the close end as point C.

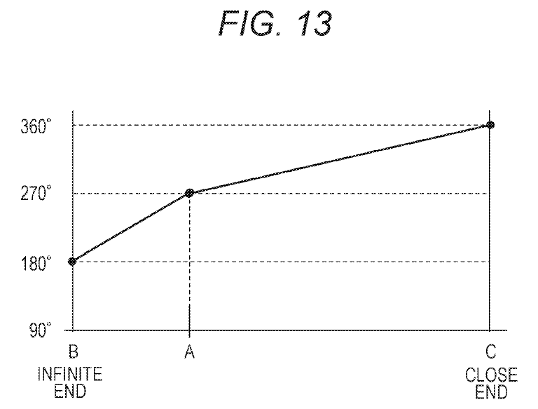

In the present embodiment, as illustrated in FIG. 13, point A is set at an arbitrary position closer to the infinite end between the infinite end and the close end. The operation sensitivity at the infinite end (point B) is set to 180°, the operation sensitivity at point A is set to 270°, and the operation sensitivity is set to continuously change linearly in the A - B section. Furthermore, the operation sensitivity at the close end (point C) is set to 360°, and the operation sensitivity is also set to continuously change linearly in the A - C section.

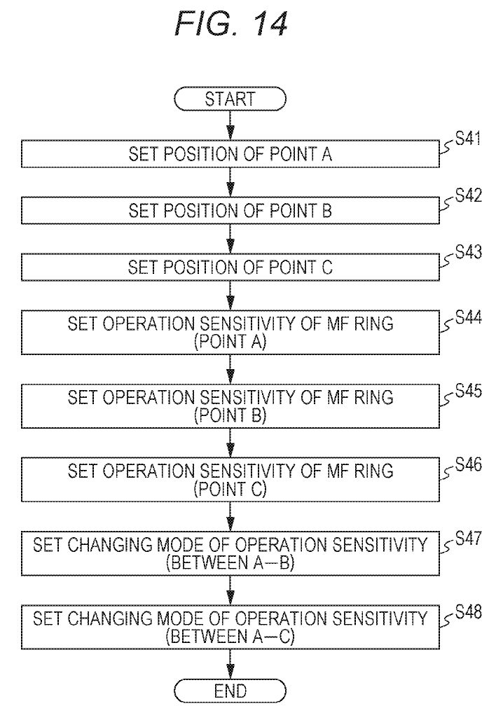

FIG. 14 illustrates an example of a setting process for setting the section and the operation sensitivity in the present embodiment. Next, in step S41, the position of point A in the working range is set, then in step S42, the position of point B in the working range is set, and then in step S43, the position of point C in the working range is set. Next, the operation sensitivity at point A is set in step S44, the operation sensitivity at point B is set in step S45, and the operation sensitivity at point C is set in step S46. The setting of each point and each operation sensitivity can be executed similarly to the setting of the point and the operation sensitivity in the first embodiment described above.

Next, in step S47, the changing mode of the operation sensitivity in the A - B section is set, and in step S48, the changing mode of the operation sensitivity in the A - C section is set. The changing mode of the operation sensitivity can be set by selecting a specific mode such as “linear” from among various changing modes such as“ linear” or “non-linear” stored in advance in the CPU by an operation from, for example, a button of the lens unit, an input device in a camera main body mounted with the lens unit, or an external device such as a smartphone or a personal computer connected to the lens unit.

According to the present embodiment, it is suitable to photograph a video image that emphasizes an effect of shifting the focus such that focusing out is performed at different speeds in stages from an infinite end in focus toward point A and from point A toward a close end.

Note that the illustrated mode is a mode in which the operation sensitivity changes linearly, but when a non-linear change is set, it is effective from the viewpoint of providing a sense of speed to a change in which focus is shifted or giving subtle nuances of expression. Examples of the video image having such an effect include a video image in which a main subject is at point A, focusing in is performed from the infinite end toward point A, and focusing out is performed from point A to the close end.

### Other embodiments

In the above-described embodiment, the section is set by the position of the optical element in the working range of the optical element. The mode of setting the section in this manner is advantageous in that a plurality of operation sensitivities can be set without depending on the order of operations by the operation ring within a range in which the sections do not overlap. On the other hand, the present invention may include other embodiments other than the above-described embodiments as long as the effects of the present invention can be obtained.

For example, in the present invention, two or more sections in the working range of the optical element may be set in the setting process according to the state of the operation of the operation ring. For example, in the setting process, the operation sensitivity may be independently set according to each time of the number of the series of rotary motions of the operation ring. The number of series of rotary motions may be determined, for example, by the elapsed time after the rotary motion of the operation ring has stopped (such as after n seconds). By setting each time of the series of rotary motions of the operation ring as a section in the working range of the optical element in this manner, it is possible to operate the optical element with different operation sensitivities according to the operation of the operation ring for the first time and the operation of the operation ring for the second time, in other words, it is possible to switch the operation sensitivity according to “what number of ring operations”. This aspect is advantageous in a case where it is difficult to specify the photographing distance of a subject in advance in a scene where the specific subject is photographed. For example, it is advantageous in photographing a scene in which a subject who has moved to an arbitrary photographing distance stops to some extent and then moves again (e.g., a scene in which an actor who has walked stops, does something, and then focuses out).

Note that in the above mode, it is preferable that the control unit can further execute a restart process of restarting the working process from the beginning of the set section and the operation sensitivity in the middle of the set section. According to such restart process, in a case where it is desired to redo the photographing of the scene from the beginning, it becomes possible to restart the photographing with the section and the operation sensitivity set once, and it is preferable from the viewpoint of saving the trouble of redoing the setting process. The restart process can be executed by the control unit temporarily storing the contents of the setting process in the storage unit and performing a process of reading the contents. Furthermore, the restart process can be performed, for example, by the user pressing a reset button provided in the lens unit, or by a specific operation (e.g., long pressing) of a button or a switch of another function.

Furthermore, in the present invention, only two or more different operation sensitivities and the order thereof may be set in the setting process, and in the working process, the operation sensitivity set according to a specific input signal by the user may be changed in the set order. The input signal may be output to the control unit when the user executes a specific operation (e.g., a long pressing or a double pressing) on a button or a switch provided in the lens unit. Alternatively, the input signal may be a specific signal (e.g., a designation signal of an object distance) from an external device (e.g., a smartphone) connected to the lens unit. Since the section in the working range of the optical element is not set in advance, this mode is suitable from the viewpoint of saving the setting and from the viewpoint of being able to perform photographing flexibly corresponding to the situation of the photographing site.

Furthermore, in the above-described embodiment, when the optical element is moved across the boundary of the sections, the operation sensitivity may be returned to the operation sensitivity set in the section by the rotation in the reverse direction of the same rotation amount as the rotation amount in the forward direction of the operation ring. In this mode, when the user erroneously turns the operation ring too much, the operation sensitivity set in the section can be returned by reverse rotating the operation ring by the same rotation amount. Therefore, the user who is performing the photographing can intuitively correct the operation sensitivity by the rotation operation of the operation ring, which is suitable from the viewpoint of maintaining the comfort of the user in photographing.

Furthermore, in the first to fourth embodiments described above, in a case where the optical element is moved beyond the set section in the working process, the control unit may apply a specific operation sensitivity regardless of the operation sensitivity set in the section. In this mode, for example, when the specific operation sensitivity is set to 0°, the working of the optical element due to excessive rotation of the operation ring becomes substantially invalid. Therefore, it is suitable from the viewpoint of preventing a change in operation sensitivity due to an excessive rotating operation (erroneous operation) of the operation ring by the user and maintaining comfortable photographing conditions of the user.

Furthermore, in the embodiment described above, the hysteresis width may be set at the boundary of the set sections. In this mode, for example, the operation sensitivity is switched at the boundary of the sections in the forward direction of the rotating direction of the operation ring, and the operation sensitivity is switched according to the set hysteresis width in the reverse direction of the rotating direction. Such a mode is suitable in a case where the operation in the forward rotating direction is more prioritized in the photographing. This mode is advantageous from the viewpoint of obtaining an effect in photographing similar to the case of setting the operation sensitivity of the buffer section described above according to the rotating direction of the operation ring (moving direction of the optical element), and simplifying the setting process as compared with the case.

Furthermore, in the embodiment described above, the operation mechanism for operating the optical element is a physical operation ring, but in the present invention, the operation mechanism merely needs to be able to operate the optical element, and can be similarly applied to not only the physical ring but also an electronic operation unit (e.g., a slider of a smartphone). Such an operation unit may be, for example, an operable user interface (UI) displayed on a touch panel, and the touch panel may be configured integrally with the lens unit, or may be configured to communicate with the lens unit in a wired or wireless manner.

### Summary

As is clear from the above description, in the present invention, the operation of setting the operation sensitivity during photographing is unnecessary every time the operation sensitivity changes by setting the section in the working range of the optical element and the operation sensitivity at that time in advance. As described above, in the present invention, a plurality of application sections of the operation sensitivity can be arbitrarily designated, and a plurality of operation sensitivities can be applied by a series of operations of the optical element without resetting for each operation sensitivity.

A first aspect of the present invention is a lens unit (zoom lens) including: a lens optical system including an optical element (focus lens group) to be operated, an operation unit (MF ring) that is an operable operation unit and configured to work the optical element according to an operation amount to change an operation of the optical element in the lens optical system, and a control unit (CPU) configured to execute a setting process of setting two or more sections in a working range of the optical element on which the optical element operates in the lens optical system and two or more different operation sensitivities of the operation unit corresponding to each of the two or more sections, and a working process of working the optical element with the operation sensitivities set in the setting process in the sections set in the setting process to change the operation of the optical element according to the operation of the operation unit. According to the first aspect, a lens unit capable of changing an operation sensitivity of an optical element during photographing without interrupting photographing can be provided.

According to a second aspect of the present invention, in the first aspect, a boundary between two or more sections is set by a position of the optical element in the working range of the optical element. The second aspect is more effective from the viewpoint of enabling two or more scenes in which different operations of the optical element are required to be continuously photographed with suitable operation sensitivity according to each scene without changing the operation sensitivity (interrupting photographing).

According to a third aspect of the present invention, in the first aspect or the second aspect, the operation sensitivity is invariable with respect to a change in operation of the optical element in at least one of the two or more sections. The third aspect is more effective from the viewpoint of realizing photographing with suitable operation sensitivity according to a subject.

According to a fourth aspect of the present invention, in any one of the first to third aspects, the operation sensitivity is set in the setting process in accordance with the direction of change in operation of the optical element in at least one of the two or more sections. The fourth aspect is more effective from the viewpoint of photographing a specific subject with suitable operation sensitivity following the photographing of the video effect due to the change in the operation of the optical element.

According to a fifth aspect of the present invention, in any one of the first to fourth aspects, the operation sensitivity is variable with respect to a change in operation of the optical element in at least one of the two or more sections. The fifth aspect is more effective from the viewpoint of realizing photographing that achieves a video effect due to the change in the operation of the optical element in the set section.

According to a sixth aspect of the present invention, in any one of the first to fifth aspects, the two or more sections further include a buffer section adjacent to at least one of the sections, and when the operation sensitivity set in the section adjacent to the buffer section is defined as a reference operation sensitivity, the operation sensitivity in the buffer section is set to the reference operation sensitivity or to gradually change to the reference operation sensitivity in the setting process. The sixth aspect is more effective from the viewpoint of maintaining or enhancing the comfort of moving image photographing by the user.

According to a seventh aspect of the present invention, in any one of the first to sixth aspects, the optical element is a focus lens group, and the operation unit is a manual focus ring. The seventh aspect is more effective from the viewpoint of enabling a moving image excelling in a video effect of focusing to be photographed.

An eighth aspect of the present invention is an imaging apparatus including: the lens unit according to any one of the first to seventh aspects; and an image sensor configured to convert an optical image formed by the lens unit into an electrical signal on an image plane side of the lens unit. According to the eighth aspect, an imaging apparatus capable of changing an operation sensitivity of an optical element during photographing without interrupting photographing can be provided.

According to the present invention described above, it becomes possible to change the operation sensitivity of the optical element during photographing without interrupting the photographing in the photographing of the moving image by the imaging apparatus. The present invention having such an effect is also expected to contribute to the achievement of, for example, the goal 9 of the sustainable development goal (SDGs) proposed by the United Nations (UN), “Make the basis for industries and technological innovations”.

The present invention is not limited to the above-described embodiments, and various modifications can be made within the scope of the claims. Embodiments obtained by combining as appropriate technical means disclosed in relation to different embodiments are also included in the technical scope of the present invention.

What is claimed is:

1. A lens unit comprising:
a lens optical system including an optical element to be operated;
an operation unit that is an operable operation unit and configured to work the optical element according to an operation amount to change an operation of the optical element in the lens optical system; and
a control unit configured to execute a setting process of setting two or more sections in a working range of the optical element on which the optical element operates in the lens optical system and two or more different operation sensitivities of the operation unit corresponding to each of the two or more sections, and a working process of working the optical element with the operation sensitivities set in the setting process in the sections set in the setting process to change the operation of the optical element according to the operation of the operation unit.

2. The lens unit according to claim 1, wherein a boundary between the two or more sections is set by a position of the optical element in the working range of the optical element.

3. The lens unit according to claim 1, wherein the operation sensitivity is invariable with respect to a change in operation of the optical element in at least one of the two or more sections.

4. The lens unit according to claim 1, wherein the operation sensitivity is set in the setting process in accordance with a direction of a change in operation of the optical element in at least one of the two or more sections.

5. The lens unit according to claim 1, wherein the operation sensitivity is variable with respect to a change in operation of the optical element in at least one of the two or more sections.

6. The lens unit according to claim 1, wherein
the two or more sections further include a buffer section adjacent to at least one of the sections, and
when the operation sensitivity set in the section adjacent to the buffer section is defined as a reference operation sensitivity, the operation sensitivity in the buffer section is set to the reference operation sensitivity or to gradually change to the reference operation sensitivity in the setting process.

7. The lens unit according to claim 1, wherein the optical element is a focus lens group, and the operation unit is a manual focus ring.

8. An imaging apparatus comprising:
a lens unit according to claim 1; and
an image sensor configured to convert an optical image formed by the lens unit into an electrical signal on an image plane side of the lens unit.
